(19) United States
(12) Patent Application Publication
(10) Pub. No.: US 2018/0210964 A1
(43) Pub. Date: Jul. 26, 2018

(54) THIRD-PARTY DATABASE INTERACTION TO PROVISION USERS

(71) Applicant: VaultDrop, Los Angeles, CA (US)

(72) Inventors: Arash Esmailzadeh, Los Angeles, CA (US); Touradj Barman, San Diego, CA (US); Darren Kelley, Houston, TX (US)

(21) Appl. No.: 15/875,908

(22) Filed: Jan. 19, 2018

Related U.S. Application Data
(60) Provisional application No. 62/448,962, filed on Jan. 21, 2017.

(51) Int. Cl. G06F 17/30; G06Q 30/02

(52) U.S. Cl. CPC G06F 17/30882; G06F 17/30371; G06Q 30/0201; G06F 17/3089; G06F 17/30312

(57) ABSTRACT

Various systems and methods are disclosed. For example, one method may include identifying at a sponsor service that a new user has been added to a user database operated by a third-party server; retrieving user data associated with the new user from the user database, the user data including a user communication address; creating a unique link for the new user that uniquely identifies the new user, the unique link directing the new user to a graphical page with data entry fields; communicating the unique link to the user communication address via a communication channel; receiving data entry information from the graphical page, the data entry information including data associated with the unique link; and validating that the data entry information is from the new user based on the data associated with the unique link.

### SUMMARY

Embodiments of the invention include a method for identifying at a first service, or sponsor service, that a new user has been added to a user database operated by a second service, or third-party server, system or service provider; retrieving at the first service user data associated with the new user from the second service user database, the user data including a user communication address; creating a unique link for the new user that uniquely identifies the new user, the unique link directing the new user to a graphical page with data entry fields; communicating the unique link to the user communication address via a communication channel; receiving data entry information from the graphical page, the data entry information including data associated with the unique link; and validating that the data entry information is from the new user based on the data associated with the unique link.

Some embodiments may also include storing the data entry information in a customer database with the user data.

In some embodiments, the communication address comprises an email address and the communication channel comprises the Internet. In some embodiments, the communication address comprises a phone number and the communication channel comprises a wireless network.

In some embodiments, the unique link includes a unique code, and wherein the data associated with the unique link comprises the unique code.

In some embodiments, the page comprises a webpage or a page provided by an application.

In some embodiments, one or more data entry fields are populated with data associated with the unique link.

These illustrative embodiments are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings.

FIG. 1 is a block diagram showing the sponsor service coupled with a customer database that may include customer information and/or customer records according to some embodiments.

FIG. 2 is a flowchart of an example process for a sync service according to some embodiments.

FIG. 3 is a flowchart of an example process for a sync service according to some embodiments.

FIG. 4 is a flowchart of an example process for an email verification flow according to some embodiments.

FIG. 5 is a flowchart of an example process according to some embodiments.

FIG. 6 illustrates an example process for forwarding content with a destination specification according to some embodiments.

FIG. 7 illustrates an example process using a user validation process according to some embodiments.

FIG. 8 shows an illustrative computational system for performing functionality to facilitate implementation of various embodiments described in this document.

### DETAILED DESCRIPTION

Some embodiments of the invention include systems and/or methods for provisioning clients from a first customer group into services of a second customer group. For example, when a given customer of the first customer group leaves or is removed from the first customer group the services provided for the second customer group are no longer provided. Some embodiments of the invention include various methods and systems related thereto.

Some embodiments include systems and/or methods that can automatically verify the identity of a user, for example, when the user selects a link that has been emailed to the user. In some embodiments, the link may include a unique code that can be used to verify the identity of the user selecting the link.

There may be advantages for a first service (or first service provider or service provider) to provide a second service, possibly provided by an entity that is not the same as the first service provider, to a target group, which might include of one or more of the first service's and/or other entities' customers, former customers, potential new customers, or others, including any group of any kind, classifiable by one or more of any attribute, or combination of any of those and/or others. The target group may include members or users, being actual users, potential users, former users, partial users, non-users, a subset of users defined in any way, etc. of one or more of the services, for example of the first service. The services could be of any variety, technologically based or not. The services may be recurring, or not.

A service could be any service or transaction provided and/or owned by a service provider. A service provider may be a company, organization, partnership, individual, country, state, or other entity of any kind, or any combination thereof or otherwise including any parts or wholes. A first service or service provider could be any person, company, or other entity that has any amount of ownership, management, control, interest, or other relationship and/or association and/or potential association of any kind to the first service. A service or service provider could also be any entity that has ownership or management rights to the first service or its owner or operator. A service could be of any type. Throughout this document service and service provider may be used interchangeably, e.g. first service and first service provider may mean the same thing. Additionally, system and service may be used interchangeably. For example, one service could be physical self-storage and another could be online cloud storage.

In some embodiments, the second service may include a plurality of second services. For instance, a listing of second services may be provided to the user and the user may be allowed to choose one of second services from the listing of second services. In some embodiments, the listing of second services may be a dynamic list that various depending on the demographics of the user. For instance, an artificial intelligence algorithm or engine can determine which second services should be provided to a given user based, for example, on the user's demographics and/or history.

The second service, for example, can include any type of service. One example service may include a cloud-based image (or photograph) management service. When a user takes a picture using their smartphone, the cloud-based image management service can automatically upload the resulting image to the cloud-based image management service. This service may be used as the primary storage location for the images taken, or as an additional storage location. This service, for example, can typically be provided based on the amount of online storage used or allocated to the user. For instance, a first price may be associated with a first online storage allocation; and a second price may be associated with a second online storage allocation. In addition, this cloud-based image management service can also be provided in association with the first service for free or at a reduced price. In some embodiments, as part of the image management service, the user may have an app executing on the mobile device of a cloud-based image management service may recognize that an image has been captured and upload it to the cloud-based image management service.

A service may have one or more facilitating services. For example, a first service could be provided to users in part or whole through infrastructure and/or services and/or capital and/or labor and/or servers and/or technology provided by one or more third parties, i.e. an infrastructure partner. It is possible that the second service and/or its agents or proxies, could interface with one or more infrastructure parties as a proxy of the first service, or one or more of the infrastructure partners could interface with the second service or one or more agents or proxies of the second service to facilitate the conducting of anything mentioned in this document. For example, a first service could be self-storage, e.g. Right Move Self Storage and that self-storage could have a database of its customers and related information maintained in part or whole by an infrastructure partner, e.g. SiteLink, and the second service, for example a cloud storage service, e.g. VaultDrop could interface with the infrastructure partner to conduct activities mentioned or referenced in this document for the first service, for example the aforementioned self-storage.

Providing one or more services in conjunction with another is sometimes known as bundling, meaning that multiple services are provided together providing advantages, such as a lower price, greater efficiencies, etc. than with providing the services individually. Bundling can also result in savings via efficiencies to the provider or providers of the services, as well as to the customers. For example, billing can be consolidated such that the customer receives one bill for both services. Points of purchase can be reduced and/or combined. Economies of scale may be attainable through the reduced capital and/or labor costs required to provide, support and/or bill two or more services, in whole or in part, together and/or in conjunction and/or coordination with each other. There may also be marketing advantages, for example, by getting information about brands or offers in front of target groups.

The second service may be provided free to the target group, or it may be provided in exchange for a fee, which could be a reduced fee, either of which could be direct or indirect, either known or not known to the target group. The first service might pay the fee for the second service to be made available to the target group. The first service may or may not incorporate and/or adjust fees it charges the target group for the first service to provide the target group with the second service and/or its availability. For example, the first service might increase its price to its customers or other target group by an amount that covers or offsets its cost of making the second service available, whether they use it or not, to its customers. The first service might pay the cost of providing the second service to users of the first service without adjusting the price of the first service for other reasons, such as to make its first service more attractive, e.g. by making more people use or buy it, existing buyers or users use or buy it longer, etc. The first service and the second service may or may not have the same owner, provider, management, branding, characteristics, etc.

The first and/or second service may each have their own technological and/or administrative infrastructure. For example, the first service may have one or more databases, lists, files, or other records that contain, among other things, customer and/or user lists that contain, for example, identifying and/or contact information of any kind, among other information. The second service may have the same or something similar. Either or both services might be provided and/or supported in some part by one or more of any other service, technology, and/or infrastructure. Some of these services may be the same, or not.

The first and/or second service may have one or more flows, or series or sequence of events that can occur, for example a new user invitation flow. An example new user invitation flow might include a sequence of any events. An example sequence could be: (1) Send email with offer and link to join service; (2) User accepts offer in email, for example by clicking the link in the email; (3) User is taken to a webpage or app where they can create or claim their account, providing any necessary information, if needed, such as selecting a password or proceeding with an SSO service; (4) User may or may not be required to provide, change, and/or prove some or part of their contact information, for example via a subsequent email or phone number confirmation step; (5) User then gains access to their new account at the service; etc. Many other flows are possible.

In any of the fashions, or others, that the system determines when there is a new user in the target group, it can learn that a user is no longer in the target group. This can initiate a flow or process to end or otherwise change the offering and/or availability of the second service. Such flows to end a service to a user may or may not also provide conditions, such an offer, perhaps a special offer, for the user to continue the second service for a reduced cost and/or other compensation and/or for a period for free and/or with specific, perhaps limited, set of functionality and/or by performing one or more actions, perhaps specified, and/or by agreeing to see, hear and/or otherwise be exposed to and/or made aware of certain, perhaps variable marketing, branding, offers, or content or information of any kind.

Any of these flows could include one or more notifications of any kind. For example, part of a new user flow could include an email or text message announcing the availability of the second service and/or any information, links or other items to assist in claiming and/or accessing that second service. A flow to end a service could include emails and/or text messages and/or push messages and/or any other sort of message or messages to convey information related to the end of the second service or other availability. Messages with other news or offers, related or not, could be sent to a target group.

There could be flows that allow one user to invite other people, perhaps not in the target group, or in a different target or other group or not, to be offered and/or provided with the second service, a variety of the second service and/or a different service and/or be provided with the same or similar or different conditions. Flows could exist that allows a user of the first service, by way of the second service, to invite or refer someone or some entity to the first service. This might be tracked for analysis and or remunerating the user that made the invitation, perhaps no matter what, or perhaps if one or more specific events subsequently occurred, as example of which could be that the invited person makes a purchase with or otherwise uses or subscribes to the first service.

A second service can be automatically provided to a target group, for example, to current users of the first service. For this to happen, the second service may need to become aware of necessary details of and/or from the first service. For example, a second service may need to know the email addresses belonging to users in the target group and some or all of this information may reside in, be accessible by, or otherwise be known by the first service, or be available via an agent or proxy of the first service. The second service may additionally benefit from having other information of the target group, for example, users' names, unique identification numbers proprietary to or otherwise used by the first service, etc. This information may be received at the second service in any way. Some ways, but not all, that this may occur include:

At intervals, which may or may not be preset and/or occur or change according to some algorithm and/or conditions, the second service, or an agent or proxy of the second service, could query the first service, for example via an API, and make a request that may include certain perimeters, to obtain information containing or leading to knowledge of the required information to offer and/or provide the second service to the target group. This information could also be pushed from one service, possibly via any configuration of one or more infrastructure partners, to the other.

At intervals, which may or may not be preset, or which may be based, among other things, upon events, which may include events that cause a user to either be included or no longer included in a target group, the first service, or an agent or proxy of the second service, may query or push to the second service, or to an agent or proxy of the second service information containing or leading to knowledge of the required information to offer and/or provide the second service to the target group.

At any sort of interval or not, a manual process could provide to the second service, or to an agent or proxy of the second service, information containing or leading to knowledge of the required information to offer and/or provide the second service to the target group. For example, a person could enter information on a webpage or in an app.

A key, which could be a link and/or code and/or word or phrase and/or any other information could be distributed in any way to the target group. For example, keys could be sent in emails, texts, post, or any other way to a target group. Keys could also be attached to any physical object, such as a card, in any form, for example as visible content like text, or machine-readable content, such as a QR code, data contained in a magnetic stripe, electronic chip, RFID device, etc. Keys could be unique to users, or they could be unique to target groups, or they could be unique to any definable group, including any whole.

Automatic events could cause information to be transmitted, for example, proximity sensors, RFID, environmental sensors, GPS combined or not with any other location data and/or sensors, motion sensors, or any other type of sensor, whether direct or indirect or inferred based on other data, could detect a person or other entity or item, establish whether and/or something or some information or criteria related to them meet criteria to belong to the target group, and if so, then cause information containing or leading to knowledge of the required information to offer and/or provide the second service to the target group to be received by the second service, or an agent or proxy of the second service.

Any sort of interaction(s) or transaction(s) could be monitored or could cause events leading to the second service, or an agent or proxy of the second service to obtain information containing or leading to knowledge of the required information to offer and/or provide the second service to the target group.

In similar ways to the mechanisms above and/or as part of the mechanisms above, information may also be received by or be calculable by the second service or an agent or proxy of the second service that indicates when the target group should no longer receive the second service, or should receive conditions to that service or another, or receive another service, or experience any other change. For example, if a self-storage renter meets criteria to be in a target group by virtue of being a self-storage renter, and that renter ceases to be a renter, then necessary information is obtained by, or calculated by the second service or a proxy or agent of the second service so as to no longer make available or provide the second service to the now former self-storage renter. This occurrence, or one like it, could trigger other flows, such as a flow that announces and/or initiates and/or facilitates the change, such as the change of second service availability and/or applying conditions, etc.

Information indicating when a user is no longer part of a target group may be obtained by any of the methods, or methods similar to methods, or as part of the methods outlined above for receiving information indicating that user is part of the target group. It may also be calculated without a subsequent such interaction. For example, if information indicating or leading to knowledge of the duration that the user exists in the target group is obtained during or as part of or as a result of or in connection with the service indicating the user is part of the target group, then the second service or agent or proxy of the second service can automatically know when a user is no longer part of the target group. Any events or flows can be set to occur upon any of these events or any variation of these events.

For example, it could be specified that all users in the target group will exist in the target group for a duration of time from a pre-specified date and/or time, such as the date and/or time they joined the target group, the date and/or time they joined the first service, etc. Pre-specified expiration may also be based on other criteria, such as actions taken by the user, whether in the virtual or physical world. It is also possible that the complete list of current users in the target group is completely refreshed at an interval by methods including or similar to any of the methods above.

Often times, if a user signs-up for a service, such as one provided through a website, an app, an electronic device or other software or system, or even one including or involving a manual service or process, etc., the user is required to provide contact information such as one or more email address, phone number, account number, address, or any other reference information. It is well known that a user could supply anything they wish as this information, though that information may not be true. For example, a user could indicate that a one or more email addresses and/or phone numbers is theirs, but the user's entry could be a mistake, a lie, another non-truth, something that has changed, etc.

Many services, for example, may require the user to prove via a confirmation step that the contact information is theirs by sending, for example, a confirmation email to the email address provided, that email containing unique information only known by the sender or an agent or proxy of the sender, and by or via the recipient by way of receiving it at least partially through the channel used. That unique information could be a link the recipient clicks. If the same user who entered an email address subsequently clicks the link sent to the specified email address, it is proven that email address is theirs. Similar processes occur with phone numbers. Often a code is texted or verbally conveyed to a number. If the user relays the code back to the system, it is taken as confirmation the number they provided is theirs.

In some embodiments, it may be more convenient, if a user did not have to participate in a separate confirmation step to prove their contact information. For example, this confirmation step may be an additional step in a sign-up flow. For example, a user might sign-up for a service, provide an email address, then have a confirmation email sent to that email address, then have to wait for and/or find that email, click the link, allow the system to process that confirmation all before that user can access the service to with they signed-up either in part or in whole across any dimension including features or time. In some embodiments, that extra work may be undesirable for the user and thus undesirable for the service because not only of the extra process overhead, but because providing an undesirable experience to users can result in a lower perceived quality of the service.

Some embodiments may provide the capability to embed within an invitation, whether sent by email, text, or any other means, including any of those stated in this disclosure, the proof that the email or other contact information is correct. Then the user and the system can proceed without an extra confirmation step.

In some examples, three participants may be involved: a user, a service (e.g., sponsor service 105), and an invitation gateway (e.g., link service 130). The service may send a request to the invitation gateway to send an email invitation to the user. The service can specify attributes of the invitation email. These can be anything, including destination email address, name, email template to use, copy, logos, graphics, links, etc. The invitation gateway may create an invitation email that respects one or more of these attributes to be generated and sent. This may or may not be supported by one or more other services, external or not. The invitation gateway may also create the invitation email to contain a unique link generated at least in some part by the invitation gateway. The invitation email may then be sent to the email address supplied by the service. When the user receives the invitation email, they can click the unique link to arrive at a pre-specified destination from where the user can access the service, or complete their registration for the service, and proceed with the system knowing their email is confirmed without the need for a subsequent confirmation step.

The pre-specified destination, for example, could be at the service, at the invitation gateway, or at another destination. As another example, the pre-specified destination may include a webpage or application. In some embodiments, the invitation gateway could also be an identity management service, for example a service offering SSO, or single-sign on. One option is that the user, after clicking the unique link, lands at a sign-up page at the identity management service. The identity management service may require certain fields to be completed, among other things such as a contact information confirmation, to generate an account.

In one example, the identity management service may need to know of the user: (1) their email address; (2) knowledge that their email address is true and and/or confirmed; (3) their name; (4) a password they would like to use; (5) a destination service to access, possibly automatically, post sign-up; etc. Other information, or less information, or other combinations of any information, for example, could also need or be desired to be known at this step. When the user arrives, these items are known automatically as described in this document: (1) their email address, (2) knowledge that their email address is true and/or confirmed, (3) their name (for example if sent from the service to the invitation gateway and thus to the identity management service), and (5) a destination service to access, possibly automatically. Some of these fields may be editable by the user, for example, the user could edit (3) their name. Their name might be pre-populated by virtue of being transmitted through this process, but they might want to change or edit it, or they may not want to make any changes, in which case they save any effort that would be required in providing their name in this step. In this case, the user need only supply (4) a password they would like to use. Once the user does this, the identity management service can then redirect them to the service in such a way that the user is logged in to the service once they arrive and can begin interacting with and/or otherwise using the service as an authenticated user.

It may be valuable for a company, organization, individual or other entity, for example a first service or one providing or related to providing a first service, such as a first service provider, to pay for a second service to be available to a target group. As defined previously, the target group could include customers, former customers, potential customers, or any other defined group of one or more people, companies or entities. We refer to the paying entity or service as the sponsor and the recipient(s) of the availability of the second service as the sponsored user(s). The accounts in the second service that are available to the sponsored users are ones we call sponsored accounts.

For example, a self-storage company, the first service, may offer cloud storage, the second service, to its customers. In this case, the self-storage company is the sponsor and each self-storage customer is a sponsored user. The sponsored users may or may not use the second service, but they are sponsored users nevertheless.

There are multiple ways to bill for such a second service. One possibility is that all users in the designated target group are billed at a specified rate to the sponsor, i.e. the first service or first service provider. A lower price per member of the target group as compared to pricing for a single user generally can be made possible because there may exist a probability that some users of the target group may not use the second service. For example, if a second service typically cost $10 per user per month, but 50% of the members of a target group use the second service, then the sponsor can pay 50% of $10, or $5 per member of their target group. This creates a perceived lower cost per user. There is possibility for the second service to benefit as well, all depending on the relationship between the usage of the target group and the cost, value, or other pricing of the second service to be provided to one user using it.

When a first service sponsors a second service, the first service may place its logo and/or other branding and/or messaging, as well as ads of any kind, for example ads containing special offers, ads that simply reinforce brand awareness, etc. anywhere within the second service. The sponsor may additionally or instead sell and/or place other services or entities' ads anywhere within the second service. These may be called sponsor ads.

Sponsor ads may be located, presented, referenced, associated with and/or in and/or have any other sort of connection and/or relationship in and/or with certain parts of the user interface, or elsewhere. As one example, a defined location, whether specific or generally defined, on the page or other portion of the user interface or experience could contain one or more sponsor ads, even if the content and/or functionality on the page changes. As another example, sponsor ads could be displayed in more limited, but still systematic and/or similar locations, for example within the user interface of a container, such as a folder or other container, grouping or list of files, links to files, links to webpages, links to anything, content, media, or other items. A container could also be a vault, a pod, as used in services like VaultDrop and Roovy respectively. A container could be any collection of digital or non-digital items of any sort, the presentation of it, representations of it of any kind, or otherwise, even if no items happens to be present in that container.

A container could have any hierarchy. A container like a vault could contain files, which could be any item, and/or folders, within which could exist files, which could be any item, and folders, ad infinitum. One or more sponsor ads could be set to display in, near, or associated with a container, including any hierarchy of that container. A container can have a creator, or owner. It could be designated that one or more sponsor ads, or a specified type or grouping, whether static or dynamic, of sponsored ads display for any level of hierarchy for any container created by a given sponsored user. It could be set that any container, on any item in any container created or owned by a sponsored user could contain one or more ads and/or logos designated by that sponsor. This could hold true no matter who is seeing and/or otherwise interacting with the container or any of its contents, even if the user doing that is not a user, doesn't have a registered account with the service or any related services, has an account sponsored by a different sponsor or other entity, is paying for their account themselves, has a free account, etc.

Sponsored users may invite other users to the second service. This invitation could occur in any way and at any level. One way that an invitation could occur is that the sponsored user may wish to share some level of access to a container with another person. This person may not be a user of the second system yet. It could be set so that this invited user can see ads or logos designated by the sponsored user's sponsor. The user invited to the system by a sponsored user is a second-generation sponsored user. If that second-generation sponsored user invites someone to the system and that third person joins, this person is a third-generation user. This could continue ad infinitum to any number of generations. A sponsor may designate ads and logos in any combination that can be displayed to any number of generations of its sponsored users. This information can be maintained in a database.

If a user is sponsored by more than one first service or company, they could see ads owned or controlled by some or all of the first services that sponsor their account. In some cases, it could be programmed that under a given set of conditions, one or more first services' ads take any sort of precedence over other first services' ads. This could include replacing them always or a certain number of times or under certain conditions, or this could include rearranging the ad locations. For example, if a first service user shares some part of a sponsor service with a user sponsored by a different first service, these rules could be set to dictate if the second user sees the ad or ads of the first user's first service or the second user's first service, sees both, sees them in what order and/or for what duration, etc.

Ad sequencing may be defined. This may be likened to drip email campaigns, where after certain durations from a pre-defined event, e.g. sign-up, a user sees certain ads in a certain order, each ad for a certain duration which may be defined by length of time passed since any event, actions taken, or any other trigger of any kind. Actions taken could be on any service, including the first service, sponsor service, or any other service. Communication would exist to relay any or all of the information among some or all services involved to make this function.

In some embodiments, a plurality of sponsored services and/or any other services may be made available to the recipient, user, or other entity such that they can give units of the service to others. For example, Friends & Family cloud storage could be provided that includes some number of accounts, e.g., four accounts. The recipient could decide who gets these accounts by sending contact or other identifying information to a system or service that could facilitate this effort, for example, allocating the accounts. A recipient could give any number of sponsored services and/or other services from any singular and/or set of sponsored services and/or other services in any configuration to any other recipients for any duration and/or any level of functionality and/or based on any party and/or any entity relating to any party meeting any specification. This could be performed in any way via any communications channel. This could be combined with any part of this specification in any way.

There are many benefits to sponsor ads for the sponsor and others. One benefit to the sponsor is opportunity to present their branding and/or offers associated with their ads to their target group more than they can otherwise. For example, a self-storage customer might not be exposed to the self-storage's branding often because they may not access their self-storage unit, or services, often. In contrast, the second service, for example cloud storage, might be used more frequently by the customer. Thus, the self-storage service, the first service, has the opportunity to present their branding and/or messaging to their customer more times, these more times being when the customer is using the cloud storage service.

Another benefit to the sponsor is that they may sell the ad space they control on the second service. This ad space might be more valuable than average ad space because it is targeted in the sense that an entity selling services complementary, or even competitive to the first service has an audience, the sponsored users and the subsequent users they invite, that is more likely to use their services than an average, untargeted user.

Some embodiments may include a referral system. For example, if there is first user of a first service that uses the sponsor service or interacts with it in any way, and the first user shares at least some portion or reference or invitation to the sponsor service to a second person, and if the second person sees an ad or other offer provided by the first service and responds to it in any way, for example buy conducting business or activity with or in any way related to the first service, a specified fee may be paid to the first person. The fee may come from the first service or its owner. The fee may have a transaction cost deducted by the sponsor.

Some embodiments may include a system to manage referral fees. Referral fees and transaction costs, for example, can be set for various ads or actions or offers. These fees and transaction costs may or may not be different based on which action or ad the second person responds to or what size or significance of purchase, transaction or other interaction they make involving the first service. The referral fees and costs may also vary depending the number of times they're collected and/or charged to any involved party.

The system may calculate who owns which monies or other value assets to which party for any period of time. The system may interact with payment or banking services, including crypto currency and/or related services to manage any or all of these transactions, payments, accounting and/or any other aspect of this system or interactions.

Some embodiments may include a sync process to automatically provision customers onto a service that may, for example, include:

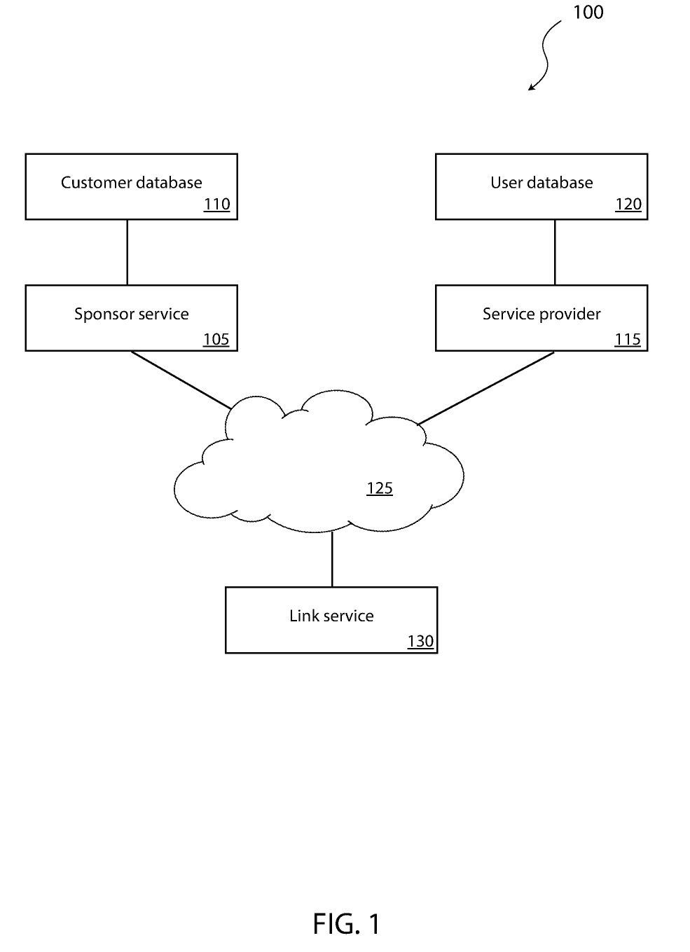

A sponsor service, which may be a system of servers, may exist that maintains customer information for sponsor customers, for example in the form of customer records for a sponsor. This may be a CRM or similar. The sponsor may maintain a process that modifies, e.g. adds, edits, and/or deletes customer records. FIG. 1 is a block diagram showing a sponsor service 105 coupled with a customer database 110 that may include customer information and/or customer records according to some embodiments.

The sponsor may provide a sponsor product or service to customers. For example, the Sponsor may provide customers with self-storage unit rentals. However, the Sponsor may be in any business or provide any service, or may be an entity or organization or group of any kind, even if it is not in business.

Customer records may include a plethora of information relating to a customer. Customer information may include, for example, for customers: customer name; customer email addresses; customer status, such as whether the customer is an active customer, a former customer or otherwise; customer start date and time, customer end date and time, Sponsor product or service purchase or consumption details, mailing address, billing data, etc.

A service provider, which may be a system of servers or a portion of a server may exist that provides a service to users. For example, this service may be a cloud storage service. The service provider may maintain user information about its users, for example in the form of user records, which are like customer records for the service provider. The service provider may be maintained by, provided by, managed by, overseen by, owned by, or otherwise have some affiliation with a service provider. FIG. 1 also show a service provider 115 coupled with a user database 120 that may include the user information and/or the user records. The service provider may communicate with the Sponsor service via the network (e.g., the Internet).

User records may include, for example, information related to a user. User information may include, for example, users' names; usernames; user IDs; user email addresses; user status, such as whether the user is an active user, a former user or otherwise; user start and end dates of being a user; service details, such as the level and/or variety of service provided to the users; pricing data, billing data, any other information that may power or constitute the information stored or provided as part of the service, associations with other companies, sponsors, etc.

A process of authentication, and the components that support it, such as user passwords, password derivatives, biometric data, or anything else that can uniquely identify the authenticity of a person as a user may exist.

A sync service or process may exist that equates, or modifies in a certain way, values, variables, or information in a sponsor's customer records, to values, variables or information in service provider's user records. This may transpire according to certain criteria. These actions may, for example, be considered record modifications.

A sync service or process may be performed in whole or in part, alone or in concert, by the Sponsor service, service provider, a third-party service, or any service or affiliate of any of these.

Filters may be employed by a sync service or process such that customer records may be filtered to isolate only ones that meet certain criteria. For example, one criteria could be active customers.

Rules may dictate criteria under which certain actions, for example record modifications, may be performed. A record modification, for example, could be to add or invite a new user to a service provider's user record.

An invite may lead to a flow. A flow may be a series of events. For example, a flow could be: an invitation flow, a sign-up flow, an on-boarding flow, an off-boarding flow, an email verification flow, or any other flows or series of events. A series of events may lead to an outcome. An example outcome could be a user becoming successfully on-boarded to a service.

Pre-set intervals may be established upon which processes are initiated, events occur, rules are followed, flows occur, criteria are measured, etc.

A service price or fee, may exist. For example, a service provider may charge a fee per user, or a total fee for a group of users. A total fee for a group of users, and/or a fee per user may vary based on service terms, which may include, for example, such variables as the type(s), tier(s), quality, quantity, amount, utilization, duration, or other attributes of services provided or made available, and/or the payer identity, payment terms, user quantity per payer, other attributes about the service, its consumption, provision, etc.; the number of users or other usage qualities or quantities of the service, the system or among a group, such as the number of Sponsor customers being provided the service, commitments made to any of these, etc.

A Sponsor may pay the service price or fee for a group of users. These users may be called sponsored users. The group of users could be any group of interest to the sponsor. Example groups of interest to a Sponsor could be: current customers, former customers, potential customers, business associates, customers of customers, etc.

A Sponsor may pay the service price or fee for a group of users so long as those people have been invited to use the service, for example by an invitation email having been sent with a special offer, regardless of if the invitees have used the service, advanced any flows, etc.

Pricing per user to the Sponsor may vary based on the usage of the service by groups for which it pays the service price or fee. Usage could be measured in any way, for example the number of people who have completed a flow such as a sign-up flow, the number of people who sign in within a time frame, the total amount of storage used by the groups, the total amount of time the service was used by the groups, etc.

Pricing tiers may exist for these variations. For example, the price per user could be $0.50 monthly if <10% of invitees have completed a sign-up flow, $1 monthly if 10%-50% have completed a sign-up flow, $2 monthly if >50% have completed a sign-up flow. Tiers could apply to other attributes of usage.

A special offer may be provided to any party. For example, a Sponsor may pay, or make commitments to pay, a service price per user to a service provider, or a beneficiary, associate, etc. of a service provider, and then a special offer may be made available to one or more Sponsor customers. For example, a special offer to become a new user of a service at no additional cost to the customer could be made. If the customer already consumes the service, the special offer may include that the Sponsor will pay the service price or equivalent for user at reduced or no further expense to the customer, possibly with or without changes to service terms.

Invitations, or notice of a special offer being made available by a Sponsor to a customer may be made via customer email addresses and/or any other communication means.

Email address verification, may exist, i.e. verifying that a person has the ability to receive emails at, or via, an email address provided. This generally suggests that this person owns, or is otherwise in control of or has sufficient access to, that email address. This is often accomplished by sending a unique link or code to that email address. If the person clicks the link or restates the code, then their email address can be verified. These same or similar processes may be applied to other channels of communication as well, e.g. verifying a telephone number, an ID on a communications network or a social or other network or system, etc.

Branding may exist for different parties or services. For example, a Sponsor might have its own branding, or Sponsor branding and a service provider might have its own branding, or service provider branding. Branding could also be ads on behalf of a Sponsor or other entity.

Sponsor branding presentation: while a sponsored user uses or in any way interfaces with a service, Sponsor branding may be presented to the user. The Sponsor branding may be presented alongside usage of the service, interspaced with usage of the service, presented in any related communications related to the sponsor, the service provider, an ancillary service provider, another company, etc., or anywhere else.

Sponsor branding down flow presentation: if sponsored users invite or share any aspect of the service with other people, who may or may not become users themselves, Sponsor branding may be displayed to these people as well. This could be the Sponsor branding belonging or controlled by the Sponsor paying the service price or fee for the sponsored user. Anyone invited to the service by someone who was invited to the service by someone who is a sponsored user may be exposed to the same or similar Sponsor branding presentation. This can continue for any quantity of further generations of invitees, up to infinity, which can be specified or not. These relationships, actions, and related data can be tracked to make this possible.

One or more ancillary service providers may exist that provide, ancillary services to support any of the services provided by either the sponsor, the service provider, another ancillary service provider, a related party or service, or that may otherwise have to do with any of the services, etc. For example, an ancillary service provider may exist that provides single sign-on (or SSO) services that may assist in user management, flows, user authentication, etc. As another example, one or more data hosting ancillary service providers may provide back-end data hosting services; a data security ancillary service provider may provide a service that encrypts data or information, etc. There could be a great quantity and variety of ancillary service providers. An ancillary service provider could provide more than one ancillary service.

A link service, for example, link service 130, may be a third-party service that provides unique links for a given user. A link, for example, may include a unique code that can be used to verify the identity of the user selecting the link.

In some embodiments, the link service 130, sponsor service 105, and/or the server provider service 115 may communicate via network 125. In some embodiments, the sponsor service 105 may communicate with the customer database 110 via network 125. In some embodiments, the service provider 115 may communicate with the user database 120 via network 125.

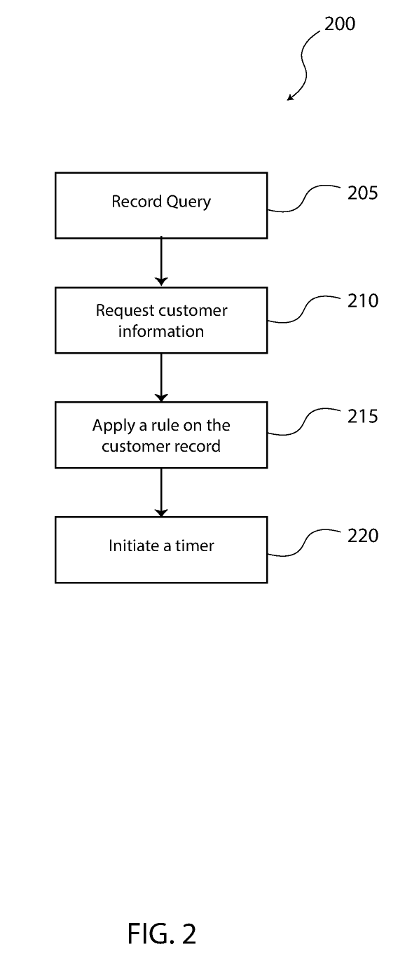

FIG. 2 is a flowchart of an example process 200 for a sync service according to some embodiments. At block 205 a service provider may query a Sponsor service's customer records with a filter that requests customer information for customers that meets criteria of a customer start date and time being equal to any value between and including the time of the query and a pre-set interval. The pre-set interval, for example, may be set for sixty, thirty, fifteen, five, or one minutes.

At block 210 the query, or a further query, may request customer information that includes customer name, customer email address, customer start date and time, customer end date and time.

At block 215 a rule may be applied. For example, if a customer record received by the query does not have a customer end date and time, an invitation flow to the service may be initiated.

At block 220 a timer may be initiated for a set period of time, for example, 5 minutes. Once the timer expires, this process may repeat.

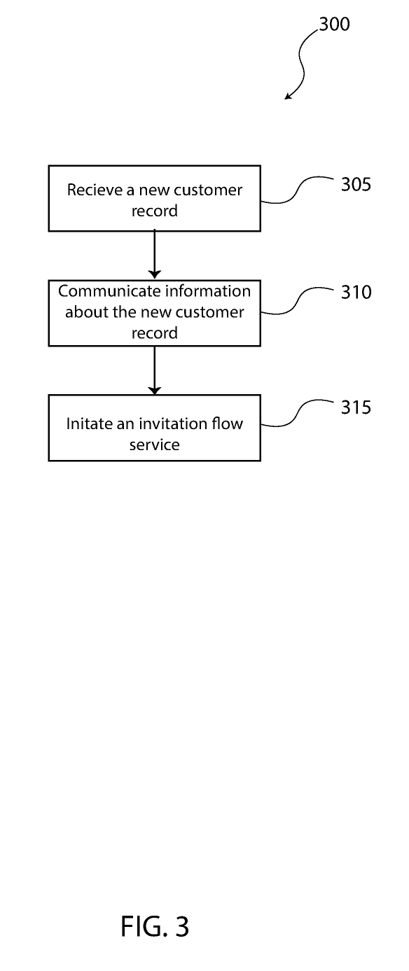

FIG. 3 is a flowchart of an example process 300 for a sync service according to some embodiments. At block 305, a customer record may be added on a Sponsor service, for example, because the Sponsor acquires a new, active customer.

At block 310, in response to receiving the new customer record, the Sponsor service, a related ancillary service, or some combination thereof may communicate information about this customer record, and/or information about its creation and/or any pertinent related activity or any instructions, rules, etc., to the service provider, a related ancillary service, or some combination thereof.

In some embodiments, it may be possible to invite a person, who may be a customer of a Sponsor or another service, to a service, while at the same time verifying that person's email address, thereby removing all or some of the typical email verification flow steps, thus making the process of signing up for a service and verifying an email address quicker, easier more pleasant, etc.

Typically, inviting someone to join a service and getting them to sign-up and verify their email address requires several steps. These may include flows such as a sign-up flow, an email verification flow, an invitation flow, etc. Examples of these may exist as follows:

In some embodiments, an email verification flow may exist for when a person signs-up to become a new user of a service, often known as following a sign-up flow.

In a sign-up flow, a person provides, usually among other information, a unique means of contact, such as an email address (but email address could be in all instances a phone number, an identifier on another network or service, etc.).

Then the service, possibly in concert with one or more ancillary services, attempts to verify the authenticity of that person's access to the email address they provided, initiating an email verification flow. Validating the authenticity or ownership is verifying that person has access privileges to receive emails sent to that address. This ability is generally accepted as confirmation that person is the owner of that email address.

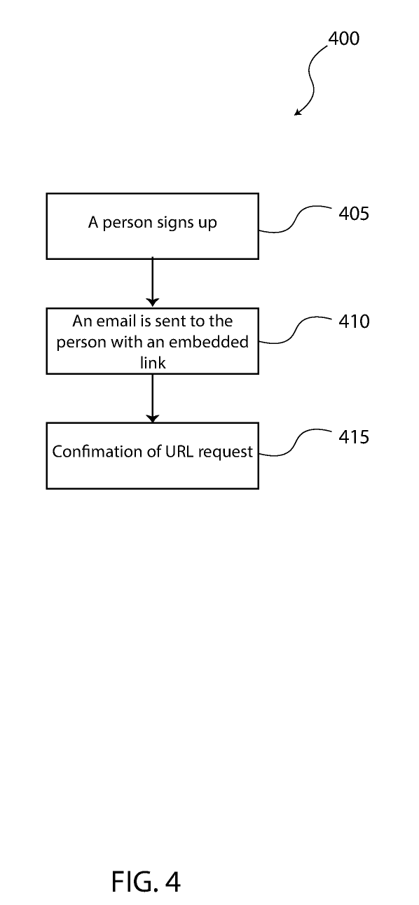

FIG. 4 is a flowchart of an example process 400 for an email verification flow according to some embodiments. At block 405 a person signs-up to become a new user of a service and enters an email address. At block 410 the service, one or more ancillary services, or a combination thereof sends an email to the provided email address. The email contains a unique link or URL, i.e. a confirmation link embedded within the message. At block 415, if the unique URL is sent to the hosting website then it may be determined that the person is associated with the email address. If the link is not clicked, it isn't verified that the user owns that email address.

A person may receive an invitation to sign-up as a new user for a service, perhaps with a special offer. Sending an invitation may initiate an, invitation flow. The goal of an invitation flow, typically, is to get the recipient of the invitation to accept the offer, or sign-up for the service.

An invitation may flow may include the following.
An invitation flow may be initiated by sending a person an email inviting them to sign-up for a service.
The invitation may describe the service, the benefits for joining, a special offer if one exists, other attributes of the service, etc. In some embodiments, a plurality of services may be offered. The invention may describe the benefits of joining each of the plurality of services.
The email may include a link or URL that leads to a destination to begin signing-up for a service, or to initiate a sign-up flow. For example, the link service 130 may generate the unique link or URL.
A sign-up flow may request a means of communication and/or identification, such as an email address. Alternatively or additionally, some other communication means may be requested or provided, such as a phone number; some unique identifier on a named service, such as a username on a messaging network; etc.
An email verification flow may be initiated. In this flow, for example:
   A unique link or URL, a confirmation link may be sent to the email address
   The email with the confirmation link may be received by the person
   The person may click the confirmation link
   The confirmation link may be accessed and make such information related to its being accessed available to the service or a related ancillary service.
   The person may be directed to the service in a signed-in state.
The person's email address may be verified, and they may be added as a user of the service

In some embodiments, if a person signs-up to be a new user of a service, even if they were invited to do so via an email sent to their email address, then once they follow instructions in that email, which may include a link to a sign-up flow that includes an email verification flow, that person has to verify their email address even though they received the invitation at their email address, which should already verify that they own, or have access to that email address.

Some embodiments may include steps that may be deemed unnecessary, and that can be removed to make the invitation flow, including the sign-up flow require fewer steps while still accomplishing the goals of an email verification flow.

In some embodiments, the steps to accomplish the goals of an invitation flow, a sign-up flow, and an email verification flow can be reduced and/or combined to accomplish the same or similar goals with fewer steps, which may translate to less time, less complexity, more ease, a better user experience, etc. for a person. These benefits may increase the percentage of people who complete the flow, thus yielding a greater quantity of successful sign-ups with verified email addresses.

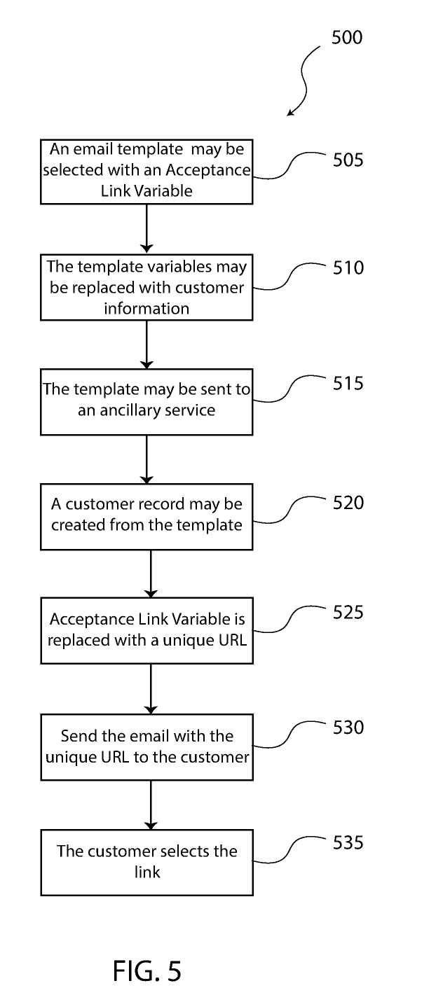

FIG. 5 is a flowchart of an example process 500. At block 505 a custom invitation email may be created. For example, one or more email templates may exist that include variables that can be replaced with their corresponding values by a service, by one or more ancillary services, or by a combination thereof.

An example email template variables may include: customer name; Sponsor name; Sponsor branding; sender name; sender email address; subject line; links; copy, such as copy describing a special offer, copy that may be part of the subject line, etc.; components of the email itself, or details related to its handling and delivery, identification of a sender, etc.; one or more links such as an invitation acceptance link, that may be the destination URL for a link; or an element with a link such as a stylized button, with a title such as accept invitation; etc.

In some embodiments, one or more email templates may be associated with a sponsor. For example, an invitation email template may have specific content and email template variables that are to be used when an invite is sent on behalf of a specified sponsor.

In some embodiments, a single sign-on service, may exist that allows for maintenance and/or creation of user records, authentication of users, performance of related or ancillary services, etc. In some embodiments, an email template to serve as an invitation email may be selected, which may correspond to a specific Sponsor and special offer.

Optionally, the selection of email template and/or one or more variables may be performed at random from among a group of ones that may remain suitable to a specific Sponsor and special offer. (this is to support AB testing, whereby the progress of a customer through flows can be tracked to measure such things as which templates, combinations of variables, etc. yield higher progress through flows, to measure performance indicators post flow completion, etc.)

At block 510, for a given customer who is to be invited to receive a special offer to join a service, certain customer information may replace corresponding email template variables. For example, the customer name variable may be replaced with the customer's actual name, e.g. John doe; the customer email address variable may be replaced with the customer's actual email address, e.g. jdoe@domain.com; etc. In some embodiments, variables relating to a special offer may be replaced with copy, imagery, and/or interactive components that detail the special offer.

In some embodiments, the email may include an invitation acceptance link. In some embodiments, the invitation acceptance link variable and/or other variables may remain variables.

At block 515 the email template, which may have one or more variables that have not been replaced with their actual values, may be sent to one or more ancillary services, such as a single sign-on service. In some embodiments, the sending may occur via an API, and other data, attributes, values and/or instructions may be included.

At block 520, upon receipt, the single sign-on service may create a customer or user record corresponding to the customer data received via the API call.

At block 525, the single sign-on service, one or more related ancillary services, or a combination thereof may replace the invitation acceptance link variable with a unique URL. This URL may be one for which the single sign-on service can obtain information it has been clicked, i.e. the link has been successfully requested by the destination server. In some embodiments, the single sign-on service may replace other email template variables that have not been replaced with their corresponding values, which may have been received via the API or other means.

At block 530, the single sign-on service, one or more related ancillary services, or a combination thereof may send or initiate the sending of the email to the customer email address. In some embodiments, data may be associated with the customer record to indicate status, such as data noting that the email has been sent, but the invitation acceptance link has not yet been clicked.

In some embodiments, timestamps may be recorded when actions occur.

In some embodiments, the customer may receive the invitation email.

At block 535 the customer may click the invitation acceptance link in the email. In response, the single sign-on service, one or more related ancillary services, or a combination thereof (or another service such as, for example, a web server) may receive an indication that the customer clicked the invitation acceptance link. The invitation acceptance link may lead the customer to a network destination, for example a webpage, where a step in a sign-up flow is to take place. In some embodiments, at block 540, the web server hosting the webpage may send an indication (or message) to the service and/or the one or more ancillary services. This indication may be used as verification that the user owns the email address.

The sign-up flow, for example, may include one or more of the following:
The destination webpage may include, among other items such as copy and imagery, fields to display or accept data for certain customer information, e.g. Customer name, customer email address, password, etc.
The fields that represent customer data that are already known may be pre-filled, for example the customer email address and customer name fields with data provided within the invitation acceptance link. Some or all of these fields may or may not be editable.
The customer supplies a password or equivalent in the password field.
The customer does not change the value in the customer email address field.
The customer may click a button or link to submit the state of the fields back to the single sign-on service (or such data transmissions could occur automatically, perhaps incrementally, as the customer interacts with the fields), one or more related ancillary services, or a combination thereof
If all the fields are complete and the customer email address has not changed from the one to which the email was sent, then the single sign-on service, one or more related ancillary services, or a combination thereof, may bypass any further email verification flows or steps because by virtue of the unique link to this destination, which was sent to this email address, being accessed and submitted it is known that the submitter has access to the customer email address.
Data in the customer record may be updated, including data including or related to password data, status information such as an indication that the destination has been accessed, data entered into fields, and submitted, the email address verified, etc.
Part or all of this data may be shared with the service, one or more related ancillary services, other systems, or a combination thereof.
The customer may be deemed a user of the service with a verified email address.
The customer may be redirected to the service in a signed-in or authenticated state.
The customer may successfully interact with the service.
The customer may use their email address and password combination to subsequently sign-in to the service or any other service whose authentication may be supported by the single sign-on service.

In some embodiments, it may be desirable to forward (or send) content (e.g., media, data, and/or references to and/or or representations and/or other forms of such items) via email (or any other communication mechanism, such as text, messenger, etc.) to a storage, cataloging and/or similar system and/or specify one or more places within the storage, cataloging or similar system where one would like the content to be placed or referenced. One example of a way to do this is to include some indicator of the destination along with the forwarding of the content.

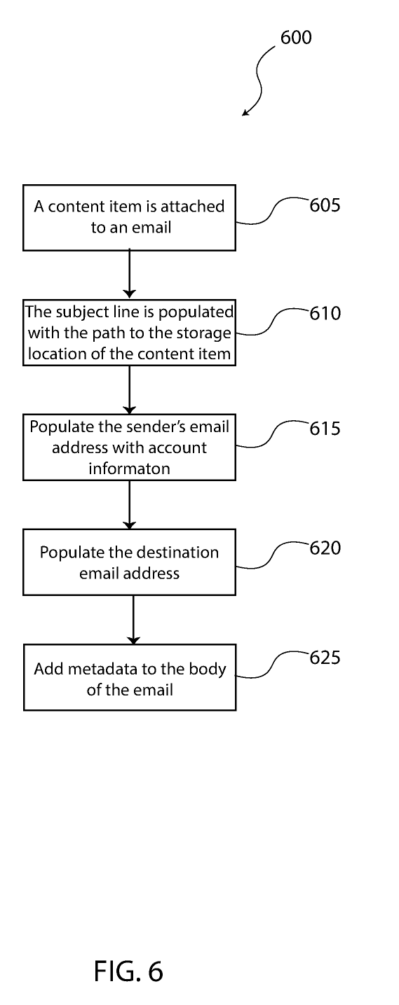

FIG. 6 illustrates an example process 600 for forwarding content with a destination specification. At block 605 it can be ensured that one or more content item(s) are in, attached to, and/or referenced in an email. For example, this could include one or more embedded images, attached files, URLs in the body of the email, etc. While an email is referenced here any type of communication channel may be used such as, for example, a text message, a chat session, an SMS message, communication between smart phone apps, etc.

At block 610, a path to a storage location for the content item may be added to the email such as, for example, the subject line of the email. For example: \owner name\drive or other container, e.g. vault name\folder name\sub-folder 1 name\subfolder 2 name. While a slash, \, is used in this example, any separator may be used. For example, the separator could be one or more dashes, -; a space, ; any combination of characters; and/or the absence of one or more characters, etc. It is possible that any element in that example destination may be absent. In cases of absence, default rules can be established to determine the location. As an example, one rule could be to deposit the item in the root directory of the first vault of the sender's account. It may also be possible to trigger the creation of the destination and/or one or more parts of the destination if the destination doesn't exist. For example, if a vault and/or folder name is specified that doesn't exist, the location could be created and then the content placed in the location. The same may be true for an account, e.g. if someone forwards content and does not have an account with the system, an account may be created for them. One or more response messages could be sent to the sender indicating an account has been made, providing a temporary password for the account, providing a link to create a password for the account, indicating that one or more of a vault, drive, storage container, folder, etc. was created, that one or more content items were successfully placed in the destination, etc.

At block 615, the sender email address may be entered into the email message. The sender email address, for example, may reference an account on the system. This information may aid in placing the content in the proper destination. The account may be referenced, for example, by entering an account number, an account identifier, an account name, etc.

At block 620, the destination email address may be populated, for example, using any email address that can be received by the system such as, for example, an intake email address associated with the system. There could be one email address that any sender could use and/or there could be specific email addresses associated with one or more senders. The system may require certain sender email addresses to be used with certain destination email addresses in order to successfully place one or more content items in one or more specified destinations.

Other functions may be specified. For example, to create two copies of an item, some indicator of such could be included within the body of the email address, e.g. 2x. To rename an item, some indicator of such could be included, e.g. Rename: [new item name].

In some embodiments, a carbon copy (cc) can be included in the email that includes email address other users that may be given access to the system and/or user account.

At block 625, metadata about the content item may be included in the body of the email. For example, an indicator of the metadata to be applied and the content to apply it to could be sent, e.g. Title: [title for content item], description: [description of content item], editors: [list of people to invite as editors], and/or authors: [the name of the person creating the content item], etc. Any shorthand can be established such that any term, character, acronym, phrase, group of terms, etc. could refer to a specific piece of metadata.

In some embodiments, specification information could be added to any part of the message and does not have to be located in the subject line. For example, specification information could be included in the body of the message, as a modification of the sender name, e.g. sendersemailaddress+destination service.com.

In some embodiments, it may be desirable to automatically place invoices (or other documents, bills, receipts, contracts, photos, videos, files, data, checks, etc.) into a structured file storage or reference system. These items, for example, may relate to a user's business or interaction with a first service, a sponsor service, or any other service, business or entity. For example, invoices from a company's system(s) may be deposited, referenced, otherwise placed, or made available on a storage or cataloging system of a user, or they may be otherwise made available to or by way of a user's account.

A storage service may query an invoice system that provides periodic invoices to one or more customers for one or more companies. In some embodiments, the invoice system may prepare invoices and/or make data to form such invoices available.

In some embodiments, the storage system may obtain one or more invoices, or data to form or generate one or more invoices from the invoice system.

In some embodiments, one or more rules may be established that may be followed by the storage system, and/or any related system. According to any rules that may be established, the invoices or references to them or their data may be organized within the storage system. A rule may be determined from data associated with an invoice and/or its data, its account details, or anything else related to it or related to anything that is related to it. For example, an invoice for December 2016 may be placed in a container such as a vault with the name of the company, e.g. [company name invoices], then within a folder, e.g. one named 2016, and then labeled with appropriate data, e.g. named [company name] invoice [date of invoice] metadata may also be applied, e.g. a description of the invoice may be applied as the description metadata of the content item in the storage or cataloging system.

In some embodiments, the invoice system may generate the invoices (or other documents or files or media) at any time. For example, they may be generated when a user clicks on a reference to an invoice in the storage system. For example, upon click of an invoice listing or link by a user, a request may be made to a URL containing information specifying which invoice is being referenced. Data, for example, may be obtained from the invoice system (or another system). That data along with formatting rules and other media, for example a company logo, may be assembled and then a file such as a PDF or other file type, e.g. a document, image, etc. generated and then that file or a representation of it may be presented to the user.

In some embodiments, the invoice may be created at any time, e.g. before, after, or at the time a user requests an invoice. In some embodiments, an invoice, its data, references to it and/or its data, may be stored for any duration of time, e.g. only so long as the user is viewing (or downloading) it, indefinitely, for a specified time period of time, for a specified quantity of views, accesses, etc.

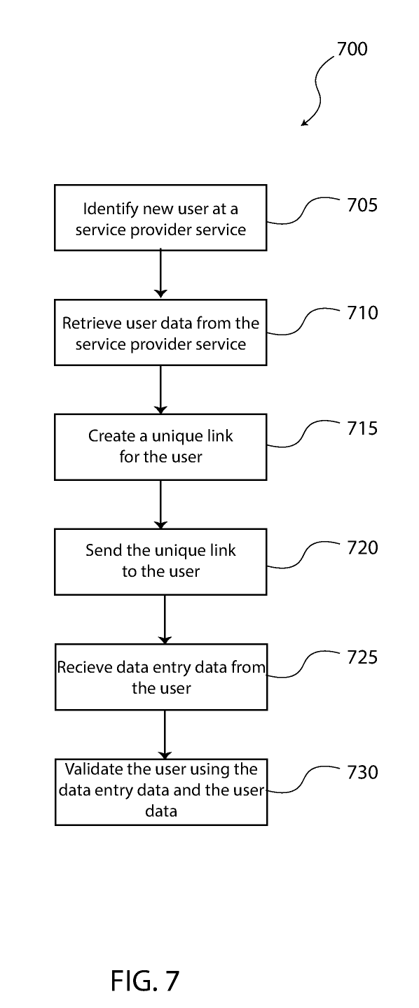

FIG. 7 illustrates an example process 700 using a user validation process according to some embodiments. Process 700 begins at block 705 where the sponsor service 105 can identify that a new user has been added to the user database 120 via the service provider 115. The sponsor service can identify that a new user has been added to the user database in any number of ways.

At block 710, the sponsor service can retrieve user data associated with the new user from the user database. The user data can include a user communication address such as, for example, an email address or a phone number. The user data may also include a user name, user preferences, etc.

At block 715 a unique link can be created for the new user. The unique link (or URL), for example, may uniquely identify the new user. The unique link, for example, may be created by the sponsor service 105 and/or the link service 130. The unique link, for example, may include a unique code that can be used to verify the identity of the user selecting the link. The unique link, for example, may include one or more items of user data. The unique link, for example, may direct the new user to a graphical page with data entry fields.

At block 720 the unique link may be communicated to the user communication address via a communication channel such as, for example, via email or text message.

The recipient of the unique link may open the link and be directed to a graphical page. At the graphical page, the user may enter data into one or more date entry fields on at the graphical page.

At block 725 the sponsor service 105 may receive data entry information from the graphical page, the data entry information including data associated with the unique link.

At block 730 the sponsor service 105 may validate that the data entry information is from the new user based on the data associated with the unique link and the user data.

In some embodiments, a variable access control service may be configured to provide and/or allow “access” or “control” such as for example service, functionality and/or data access, creation, editing or other interaction to a user or group of users based on their conditions, for example, location and/or other spatial, temporal and/or changes rates of change of and/or any derivative thereof, such as velocity, acceleration, etc. and/or any other attribute which could change or not for any reason. This variable access control, for example, could be managed for the same service and/or one or more different, e.g. first service or third-party services. For example, a container of data, such as a folder or digital vault, or any singular or multiple pieces of data like a photo, document, video, file, piece of information of any type, database or ledger entry, etc. or any service, ability and/or allowance and/or control to perform any kind of action, could have specified for its access, editing, creation and/or other interaction and/or operability where in space and/or when in time and/or under which other criteria or conditions and/or depending on defined user roles or other attributes certain users, groups of users and/or users and/or entities that meet certain defined or variable criteria can have access to or any other one or more interactions with and/or relating to it. For example, maybe a sensitive document may be viewable on a mobile device when it is located within or near (or recently in or near) the geo-coordinates and/or altitude of a specified office and/or school and/or home and/or building and/or area and/or other space, but not accessible or usable when the device and thus presumably the user are not within the specified location.

Any set of conditions, for example, may be specified in order for data access to be possible. These specifications may be modified and stored on systems like servers or other services. Various permissions levels may be required to change access specifications for any individual, entity of any kind, and/or group. Differing conditions may apply to different entities such as, for example, users, people, animals, entities of any kind living or not, machines, data, etc. Differing conditions may apply based on roles, titles, and/or any attribute of any entity.

Access levels could also change based on conditions. For example, data could be written at an office, but only viewed at a customer site by a customer. Any combination of any quantity of conditions and/or access may be programmed and/or vary based on any criteria. The data and/or functionality and/or other action or item of any kind could change based on conditions. For example, a power button could turn on lights in an office when in an office and turn off lights in a home when in a home. As another example, requesting a view of premises may show a view of an office when at that office, but show a view of a home when at a home. For privacy or security, dummy data could be shown in some conditions, for example, locations and/or times and/or entities and real data in other conditions.

These access limitations could be applied to actions, services, or anything else. For example, a mobile device may be allowed to perform one or more functions when it is physically in a certain area and operated by a certain person, but otherwise not be allowed to do so. In some embodiments, multiple persons may be required to access data and/or perform an action.

The locations or other specifications, for example, could be relative, for example, when two items are near each other, an action may be performed and/or data may be accessed. Thresholds may be established (e.g., automatically) based on any criteria or manually for any of these distances, locations or any other attribute determining access or functionality allowances for one or more users or entities or devices of any kind.

For example, a manager, or person 1, may say that a subordinate, or person 2, may access a set of computer files when they are at one of the company's offices or at the employee's home, but no where else. Person 1 could also limit access by time or any other attribute.

Any of these steps may occur in any order and/or be omitted and/or adjusted and/or replaced and/or other steps may be added.

Any item, characteristic or process may that may be performed on or in reference to one item, system, mechanism or service may be performed with any item, system, process, etc. used in its stead. For example, if destination data from an email may be used to place content in the email, then destination data from a text message or other messaging mechanism may be used to place content sent with it also.

Any of the steps anywhere in this disclosure may occur in any order and/or be omitted and/or adjusted and/or replaced and/or combined with other steps and/or be split into separate and/or partial steps and/or other steps may be added.

The above events do not necessarily have to occur in the order specified. One or more of the events may be adjusted, reordered, repeated, ignored, or removed. One or more other events may occur in any quantity at any time before, during, or after these events.

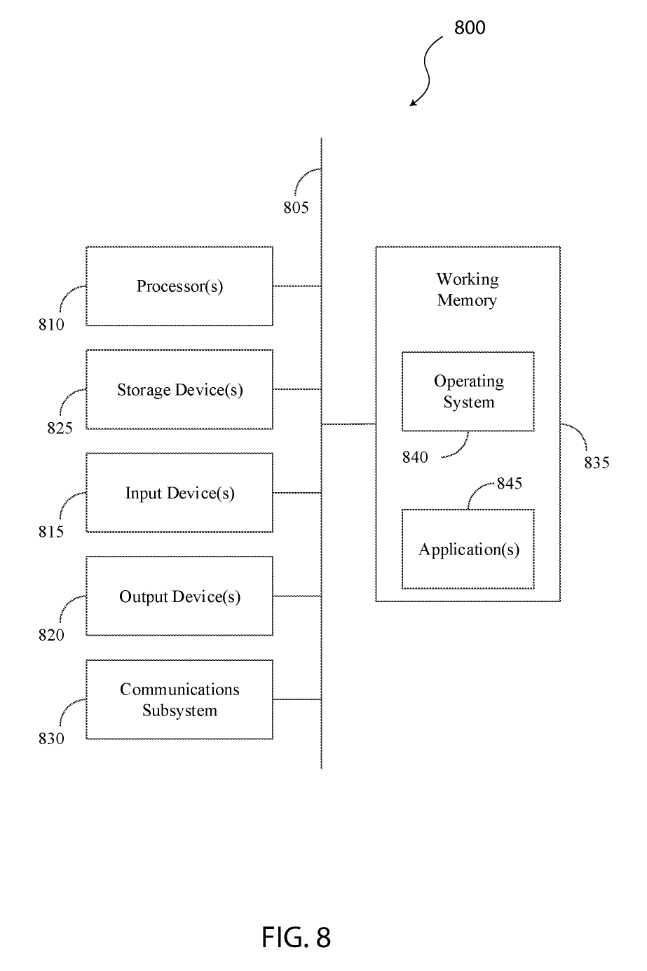

The computational system 800, shown in FIG. 8 can be used to perform any of the embodiments of the invention. For example, computational system 800 can be used to execute methods 200, 300, 400, 500, 600, and/or 700. As another example, computational system 800 can be used perform any calculation, identification and/or determination described in this document. As another example, customer database 105, sponsor service 110, user database 120, service provider 115 and/or link service may include one or more computational systems 800 or one or more components of computational system 800.

Computational system 800 includes hardware elements that can be electrically coupled via a bus 805 (or may otherwise be in communication, as appropriate). The hardware elements can include one or more processors 810, including without limitation one or more general-purpose processors and/or one or more special-purpose processors (such as digital signal processing chips, graphics acceleration chips, and/or the like); one or more input devices 815, which can include without limitation a mouse, a keyboard and/or the like; and one or more output devices 820, which can include without limitation a display device, a printer and/or the like.

The computational system 800 may further include (and/or be in communication with) one or more storage devices 825, which can include, without limitation, local and/or network accessible storage and/or can include, without limitation, a disk drive, a drive array, an optical storage device, a solid-state storage device, such as a random access memory (RAM) and/or a read-only memory (ROM), which can be programmable, flash-updateable and/or the like. The computational system 800 might also include a communications subsystem 830, which can include without limitation a modem, a network card (wireless or wired), an infrared communication device, a wireless communication device and/or chipset (such as a Bluetooth device, an 802.6 device, a Wi-Fi device, a WiMAX device, cellular communication facilities, etc.), and/or the like. The communications subsystem 830 may permit data to be exchanged with a network (such as the network described below, to name one example), and/or any other devices described herein. In many embodiments, the computational system 800 will further include a working memory 835, which can include a RAM or ROM device, as described above.

The computational system 800 also can include software elements, shown as being currently located within the working memory 835, including an operating system 840 and/or other code, such as one or more application programs 845, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a computer-readable storage medium, such as the storage device(s) 825 described above.

In some cases, the storage medium might be incorporated within the computational system 800 or in communication with the computational system 800. In other embodiments, the storage medium might be separate from a computational system 800 (e.g., a removable medium, such as a compact disc, etc.), and/or provided in an installation package, such that the storage medium can be used to program a general purpose computer with the instructions/code stored thereon. These instructions might take the form of executable code, which is executable by the computational system 800 and/or might take the form of source and/or installable code, which, upon compilation and/or installation on the computational system 800 (e.g., using any of a variety of generally available compilers, installation programs, compression/decompression utilities, etc.) then takes the form of executable code.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm may be a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as processing, computing, calculating, determining, and identifying or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of adapted to or configured to herein is meant as open and inclusive language that does not foreclose devices adapted to or configured to perform additional tasks or steps. Additionally, the use of based on is meant to be open and inclusive, in that a process, step, calculation, or other action based on one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A method comprising:
identifying at a sponsor service that a new user has been added to a user database operated by a third-party server;
retrieving user data associated with the new user from the user database, the user data including a user communication address;
creating a unique link for the new user that uniquely identifies the new user, the unique link directing the new user to a graphical page with data entry fields;
communicating the unique link to the user communication address via a communication channel;
receiving data entry information from the graphical page, the data entry information including data associated with the unique link; and
validating that the data entry information is from the new user based on the data associated with the unique link.

2. The method according to claim 1, further comprising storing the data entry information in a customer database with the user data.

3. The method according to claim 1, wherein the communication address comprises an email address and the communication channel comprises the Internet.

4. The method according to claim 1, wherein the communication address comprises a phone number and the communication channel comprises a wireless network.

5. The method according to claim 1, wherein the unique link includes a unique code, and wherein the data associated with the unique link comprises the unique code.

6. The method according to claim 1, wherein the page comprises a webpage or a page provided by an application.

7. The method according to claim 1, wherein one or more data entry fields are populated with data associated with the unique link.

8. A computing system comprising:
a customer database;
a network interface configured to communicate through a computer network; and
a processor coupled with the customer database and the network interface, the processor configured to:
identify that a new user has been added to a user database operated by a third-party system;
retrieve user data associated with the new user from the user database, the user data including a user communication address;
create a unique link for the new user that uniquely identifies the new user, the unique link directing the new user to a graphical page with data entry fields;
communicate the unique link to the user communication address via the network interface;
receive data entry information from the graphical page, the data entry information including data associated with the unique link; and
validate that the data entry information is from the new user based on the data associated with the unique link.

9. The system according to claim 8, wherein the communication address comprises an email address and the network interface communicates with the Internet.

10. The system according to claim 8, wherein the communication address comprises a phone number and the network interface communicates with a wireless network.

11. The system according to claim 8, wherein the unique link includes a unique code, and wherein the data associated with the unique link comprises the unique code.

12. The system according to claim 8, wherein the page comprises a webpage or a page provided by an application.

13. The system according to claim 1, wherein one or more data entry fields are populated with data associated with the unique link.

14. A computer program product comprising a non-transitory computer-readable medium embodying code executable by a computing system, the code comprising:
identifying at a sponsor service that a new user has been added to a user database operated by a third-party server;
retrieving user data associated with the new user from the user database, the user data including a user communication address;
creating a unique link for the new user that uniquely identifies the new user, the unique link directing the new user to a graphical page with data entry fields;
communicating the unique link to the user communication address via a communication channel;
receiving data entry information from the graphical page, the data entry information including data associated with the unique link; and
validating that the data entry information is from the new user based on the data associated with the unique link.

15. The method according to claim 1, further comprising storing the data entry information in a customer database with the user data.

16. The method according to claim 1, wherein the communication address comprises an email address and the communication channel comprises the Internet.

17. The method according to claim 1, wherein the communication address comprises a phone number and the communication channel comprises a wireless network.

18. The method according to claim 1, wherein the unique link includes a unique code, and wherein the data associated with the unique link comprises the unique code.

19. The method according to claim 1, wherein the page comprises a webpage or a page provided by an application.

20. The method according to claim 1, wherein one or more data entry fields are populated with data associated with the unique link.
